(19) United States
(12) Patent Application Publication
(10) Pub. No.: US 2023/0342808 A1
(43) Pub. Date: Oct. 26, 2023

(54) SERVICE-PROVIDING SYSTEM

(71) Applicant: Panasonic Intellectual Property Management Co., Ltd., Osaka (JP)

(72) Inventors: Hiroyoshi OHMIYA, Shiga (JP); Kiyoshi KURIHARA, Osaka (JP); Takuro ITO, Tokyo (JP)

(21) Appl. No.: 18/012,549

(22) PCT Filed: Jun. 30, 2021
(86) PCT No.: PCT/JP2021/024803

§ 371 Date: Dec. 22, 2022

(30) Foreign Application Priority Data
Jul. 9, 2020 (JP) 2020-118138

(51) Int. Cl. G06Q 30/0235; G06Q 30/0207

(52) U.S. Cl. CPC G06Q 30/0236; G06Q 30/0235

(57) ABSTRACT

A service-providing system (300) includes a screen provider (301), a user information manager (304), and a coupon information manager (305). The screen provider (301) is configured to provide a communication terminal of a user with a registration screen for registration for use of a periodic delivery service including a combination of the provision of a cooking appliance and the periodic provision of coupon information allowing purchase of a foodstuff corresponding to the cooking home appliance. The user information manager (304) is configured to store user information on the user who has completed the registration for the use of the periodic delivery service. The coupon information manager (305) is configured to periodically generate the coupon information to be provided to the user on whom the user information is stored in the user information manager (304).

### BACKGROUND

### 1. Technical Field

The present disclosure relates to a service-providing system configured to provide a service related to the provision of home appliances.

### 2. Description of the Related Art

In recent years, there has been known a business model in which payment is not made every commodity, but made at a flat rate every predetermined period (for example, every month). This business model is called a subscription, and has been widely used in contents distribution services, such as music, video, and digital book distribution services. As to this subscription business model, Patent Literature 1 discloses a flat rate plan-providing apparatus with which a provider that directly provides commodities and services for a user off-line can easily and efficiently offer a flat-rate plan.

### Citation List

Patent Literature 1: Japanese Unexamined Patent Application Publication No. 2020-067963

### SUMMARY

The present disclosure provides a mechanism for providing a new service including a combination of the provision of a home appliance and the provision of a consumable item corresponding to the home appliance.

A service-providing system according to the present disclosure includes a screen provider, a user information manager, and a coupon information manager. The screen provider is configured to provide a user’s communication terminal with a registration screen for registration for use of a service, the service including a combination of the provision of a home appliance and the periodic provision of coupon information allowing purchase of a consumable item corresponding to the home appliance. The user information manager is configured to store user information on a user who has completed the registration for use of the service. The coupon information manager is configured to periodically generate coupon information to be provided to the user whose user information is stored in the user information manager.

The service-providing system according to the present disclosure can provide a mechanism for providing a new service including a combination of the provision of a home appliance and the provision of a consumable item corresponding to the home appliance.

### BRIEF DESCRIPTION OF THE DRAWINGS

FIG. 1 is a diagram illustrating the flow of a periodic delivery service in Embodiment 1.

FIG. 2 is a diagram illustrating a hardware configuration of a server managed by a service provider in Embodiment 1.

FIG. 3 is a functional block diagram of a service-providing system in Embodiment 1.

FIG. 4 is a diagram illustrating a registration screen in Embodiment 1.

FIG. 5 is a diagram illustrating a user information database in Embodiment 1.

FIG. 6 is a diagram illustrating a coupon information database in Embodiment 1.

FIG. 7 is a diagram illustrating the body of an e-mail in Embodiment 1.

FIG. 8A is a diagram illustrating a foodstuff purchase screen in Embodiment 1.

FIG. 8B is a diagram illustrating a coupon information input screen in Embodiment 1.

FIG. 8C is a diagram illustrating a confirmation screen in Embodiment 1.

FIG. 9 is a flow chart of processing executed by the service-providing system in Embodiment 1.

FIG. 10 is a diagram illustrating the flow of a periodic delivery service in Embodiment 2.

FIG. 11 is a diagram illustrating a system configuration of the service-providing system in Embodiment 1.

### DETAILED DESCRIPTIONS

A service-providing system according to the present disclosure includes a screen provider, a user information manager, and a coupon information manager. The screen provider is configured to provide a user’s communication terminal with a registration screen for registration for use of a service, the service including a combination of the provision of a home appliance and the periodic provision of coupon information allowing purchase of a consumable item corresponding to the home appliance. The user information manager is configured to store user information on a user who has completed the registration for use of the service. The coupon information manager is configured to periodically generate coupon information to be provided to the user on whom user information is stored in the user information manager.

In the service-providing system according to the present disclosure, the user information may include at least an e-mail address. When generating coupon information, the coupon information manager may send an e-mail including the generated coupon information to the e-mail address.

Alternatively, in the service-providing system according to the present disclosure, the user information may include at least an e-mail address. When generating coupon information, the coupon information manager may send, to the e-mail address, an e-mail including a uniform resource locator (URL) for acquiring the generated coupon information.

Alternatively, in the service-providing system according to the present disclosure, the user information may include at least an e-mail address. When generating coupon information, the coupon information manager may send, to the e-mail address, an e-mail to inform a user of the issuance of the coupon information.

Using the coupon information provided via the e-mail by these methods, the user can purchase a foodstuff at a desired timing. Hence, for example, just before a foodstuff previously purchased based on the provided coupon information is consumed, the following foodstuff can be purchased. That is, the service-providing system according to the present disclosure can increase user convenience.

In the service-providing system according to the present disclosure, the home appliance may be a cooking appliance, the consumable item may be a foodstuff, and the e-mail may indicate a URL allowing access to an electronic commerce (EC) site for purchasing the foodstuff.

Thus, the user can easily access the EC site to purchase the foodstuff by making use of the URL indicated in the e-mail. That is, the service-providing system according to the present disclosure can increase user convenience.

In the service-providing system according to the present disclosure, the cooking appliance may be a rice cooker or a microwave oven. The coupon information manager may establish a correspondence between generated coupon information and an expiration date of the coupon information and store them, and when coupon information is expired, new coupon information may be generated.

Thus, in the service-providing system according to the present disclosure, an expiration date is periodically set for coupon information, so that, when the expiration date has passed, new coupon information is generated. That is, the service-providing system according to the present disclosure can provide a mechanism to periodically provide coupon information allowing purchase of a consumable item corresponding to a home appliance. The user can purchase a foodstuff by using coupon information at a desired timing before an expiration date. Thus, the service-providing system according to the present disclosure can increase user convenience.

### Embodiment 1

First, an overview of service-providing system 300 in Embodiment 1 as an example of the service-providing system according to the present disclosure will be described.

In service-providing system 300 according to the present embodiment, service provider 110 provides user 100 with a service including a combination of the leasing of a cooking appliance and the delivery of a foodstuff. Hereinafter, this service is referred to as a periodic delivery service. Periodic delivery service 1 in Embodiment 1 is an example of a service provided by the service-providing system according to the present disclosure, the service including a combination of the provision of a home appliance and the periodic provision of coupon information, the coupon information allowing purchase of a consumable item corresponding to the home appliance. The cooking appliance is an example of the home appliance according to the present disclosure. The foodstuff is an example of the consumable item corresponding to the home appliance according to the present disclosure.

Service provider 110 provides (leases) a cooking appliance, such as a microwave oven or a rice cooker, to user 100. Furthermore, service provider 110 periodically provides user 100 with coupon information allowing purchase of a foodstuff corresponding to the cooking appliance. Using the coupon information, user 100 purchases the foodstuff corresponding to the cooking appliance from foodstuff provider 120. For example, in the case where the cooking appliance provided to user 100 is a microwave oven, coupon information allowing purchase of a meal kit frozen for preservation is provided to user 100. For example, in the case where the cooking appliance provided to user 100 is a rice cooker, coupon information allowing purchase of rice is provided to user 100.

Periodic delivery service 1 in the present embodiment is a business model called a subscription. The subscription means not a system in which a payment is made every commodity, but a system in which a fixed amount of a usage charge is paid every predetermined period (for example, every month). In the case of periodic delivery service 1 in the present embodiment, by paying a usage charge at a fixed rate every month, user 100 can acquire (lease) a cooking appliance, and furthermore, coupon information allowing purchase of a foodstuff is provided to user 100 every month.

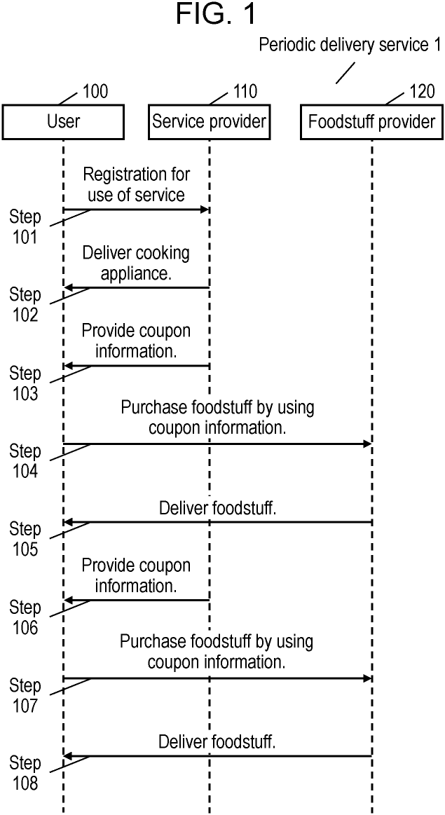

Using FIG. 1, the flow of periodic delivery service 1 in Embodiment 1 will be described. FIG. 1 is a diagram illustrating the flow of periodic delivery service 1 in Embodiment 1. As illustrated in FIG. 1, using communication terminal 10 owned by user 100, user 100 accesses a Web page prepared by service provider 110, selects a desired plan, and performs registration for use of periodic delivery service 1 (Step 101). Note that the plan will be described later. When the registration for use is completed, service provider 110 delivers, to user 100, a cooking appliance corresponding to the plan registered by user 100 for use (Step 102).

Next, service provider 110 provides user 100 with coupon information allowing purchase of a foodstuff (Step 103). The coupon information is, for example, a string of random letters and numbers (a string in which random letters and numbers are combined), and is provided to user 100 by e-mail. In other words, in the present embodiment, service provider 110 sends an e-mail including coupon information to user 100, and user 100 receives the e-mail including the coupon information. Using communication terminal 10, user 100 having received the coupon information accesses an EC site prepared by foodstuff provider 120 and purchases the foodstuff by using the coupon information (Step 104). Foodstuff provider 120 delivers the foodstuff purchased by user 100 to user 100 (Step 105). Using the cooking appliance delivered by service provider 110, user 100 can cook the foodstuff purchased from foodstuff provider 120 and enjoy a meal.

Coupon information is periodically provided to user 100. For example, after the elapse of one month following the first provision of coupon information (Step 103), the next provision of coupon information to user 100 is performed by service provider 110 (Step 106). User 100 can purchase a foodstuff again by using the coupon information (Step 107 and Step 108).

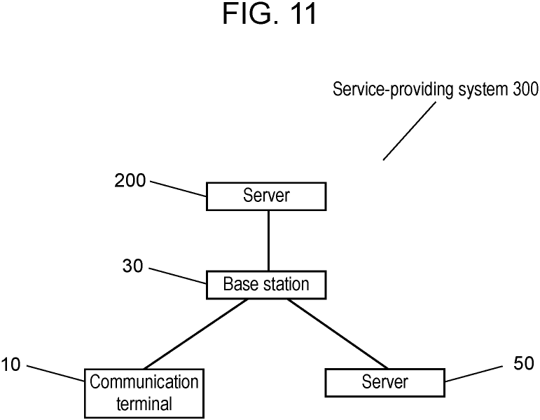

Next, a system configuration of service-providing system 300 will be described using FIG. 11. FIG. 11 is a diagram illustrating the system configuration of service-providing system 300. As illustrated in FIG. 11, service-providing system 300 includes communication terminal 10, server 50, and server 200.

Communication terminal 10 is an apparatus capable of wireless or wired communication and owned by user 100. Examples of communication terminal 10 include a personal computer (PC), a smart phone, and a tablet terminal. Server 50 is a server managed by foodstuff provider 120 and configured to perform processing related to the provision of a foodstuff. Server 200 is a server managed by service provider 110, and as described later, server 200 performs various types of processing for realizing principal functions of service-providing system 300. Communication terminal 10, server 50, and server 200 communicate with each other via base station 30. Note that this communication performed via base station 30 may be of course performed via an access point not illustrated.

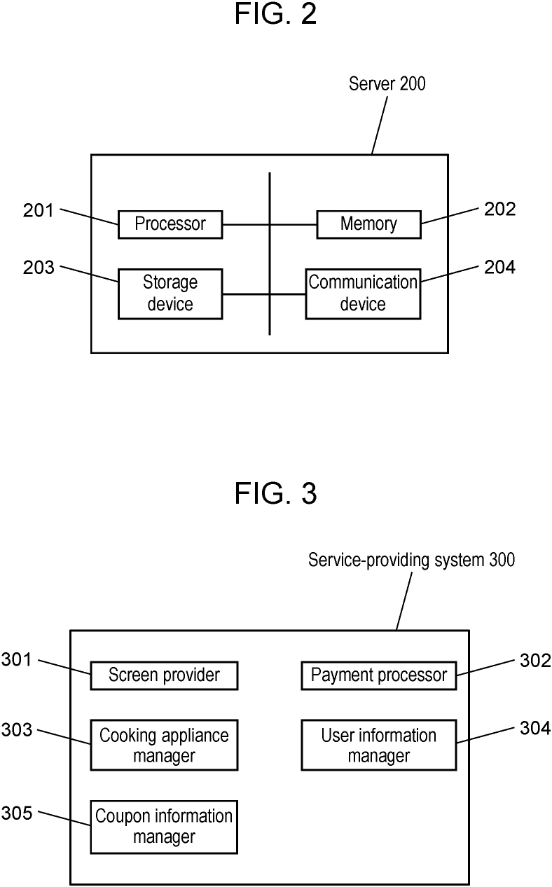

Next, server 200 serving as a principal configuration of service-providing system 300 will be described using FIG. 2. FIG. 2 is a diagram illustrating a hardware configuration of server 200.

Server 200 includes processor 201, memory 202, storage device 203, and communication device 204. Processors 201 is, for example, CPU or MPU and configured to control the operation of server 200 by reading and executing a control program stored in memory 202. Memory 202 is, for example, ROM, and configured to store the control program for server 200. Note that, herein, the control program to be executed by processor 201 is beforehand recorded on memory 202, but may be provided with being recorded on a non-temporary recording medium such as a memory card or may be provided via an electric telecommunication line such as the Internet. Storage device 203 is a nonvolatile storage medium configured to store various data. Examples of memory storage 203 include a hard disk drive. Communication device 204 is an interface configured to allow server 200 to communicate with external devices (communication terminal 10 owned by user 100 and server 50 owned by foodstuff provider 120). Communication device 204 is configured to execute wireless communications based on wireless LAN standards, such as IEEE 802.11a/b/g/n/ac, and execute wired LAN communications based on Ethernet (registered trademark).

Next, a functional configuration of service-providing system 300 will be described using FIG. 3. FIG. 3 is a functional block diagram of service-providing system 300. Processor 201 of server 200 reads and executes a control program stored in memory 202, whereby the functional block illustrated in FIG. 3 is realized.

As illustrated in FIG. 3, service-providing system 300 includes screen provider 301, payment processor 302, cooking appliance manager 303, user information manager 304, and coupon information manager 305.

Screen provider 301 is configured to provide various screens to user 100 who has accessed a Web page prepared by service provider 110. Specifically, using communication terminal 10 owned by user 100, user 100 accesses the Web page prepared by service provider 110. Screen provider 301 provides various screens related to periodic delivery service 1 to communication terminal 10 owned by user 100. Communication terminal 10 displays the provided various screens.

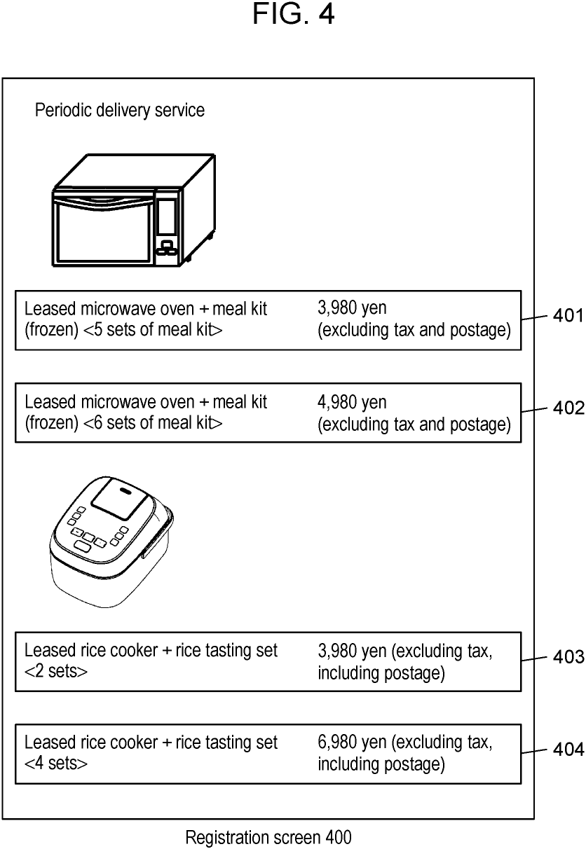

FIG. 4 illustrates an example of a screen provided to user 100 by screen provider 30. FIG. 4 is a diagram illustrating registration screen 400 for registration for use of periodic delivery service 1 by user 100. In other words, screen provider 301 provides communication terminal 10 of user 100 with registration screen 400 for registration for use of periodic delivery service 1, periodic delivery service 1 including a combination of the provision of a cooking appliance and the periodic provision of coupon information allowing purchase of a foodstuff corresponding to the cooking appliance. Then, communication terminal 10 displays provided registration screen 400.

Registration screen 400 displays four plans and respective charges for using the plans for one month (plan 401, plan 402, plan 403, and plan 404). Plan 401 and plan 402 are plans each including a combination of the leasing of a microwave oven and the provision of meal kits. Plan 401 and plan 402 are different in the number of meal kits to be provided and usage charge. Plan 403 and plan 404 are plans each including a combination of the leasing of a rice cooker and the provision of rice. Plan 403 and plan 404 are different in the number of sets of rice and usage charge. That is, the cooking appliance in the present embodiment is a rice cooker or a microwave oven. Note that, in periodic delivery service 1 in the present embodiment, the cooking appliance is leased (synonymously, rented) to user 100, and therefore, when periodic delivery service 1 is canceled, user 100 needs to return the cooking appliance to service provider 110.

When user 100 selects a desired plan out of the four plans in registration screen 400 displayed on communication terminal 10, a payment screen (not illustrated) is provided to communication terminal 10 of user 100 by screen provider 301. Communication terminal 10 displays the provided payment screen, and user 100 performs a predetermined payment operation on communication terminal 10. Upon the completion of the payment operation in payment processor 302, registration for use of periodic delivery service 1 is completed, and then the delivery of the cooking appliance (Step 102) and the first provision of coupon information (Step 103) described in FIG. 1 are executed. Note that, in the present embodiment, user 100 inputs personal information (a name, an address, a telephone number, and an e-mail address) in the above-described payment screen (not illustrated), but this is merely an example. For example, user 100 may input personal information in a screen displayed before displaying registration screen 400 or a screen displayed just after displaying registration screen 400 (before displaying the payment screen). The inputted personal information on user 100 is stored in user information database 500 as described later.

Referring back to FIG. 3, descriptions will be given. Payment processor 302 is configured to pay a charge for use of periodic delivery service 1.

Cooking appliance manager 303 is configured to manage information on a cooking appliance leased to user 100. Furthermore, cooking appliance manager 303 is configured to generate an e-mail instructing to deliver a cooking appliance to user 100 who has newly made a registration for use of periodic delivery service 1 and to send the e-mail to a person in a delivery section who is responsible for the delivery of the cooking appliance.

User information manager 304 is configured to store personal information on user 100 who is making use of periodic delivery service 1. That is, user information manager 304 stores user information on user 100 who has completed registration for use of periodic delivery service 1.

Coupon information manager 305 is configured to periodically generate coupon information to be provided to user 100 on whom user information is stored in user information manager 304. Although details will be described later, coupon information manager 305 is configured to establish a correspondence between the generated coupon information and an expiration date of the coupon information and store them. Furthermore, coupon information manager 305 is configured to, when generating the coupon information on user 100, send an e-mail including the generated coupon information to an e-mail address of user 100.

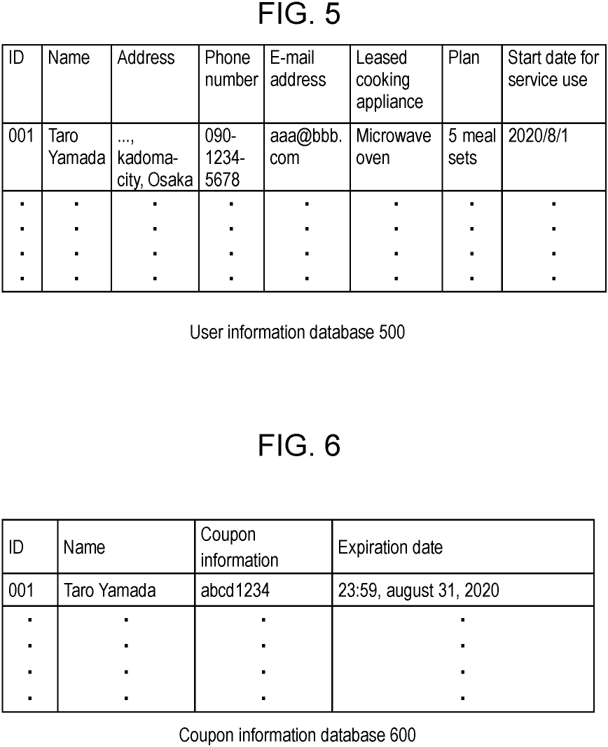

Next, user information database 500 stored by user information manager 304 will be described using FIG. 5. FIG. 5 is a diagram illustrating user information database 500. User information database 500 is a database for information stored in storage device 203 of server 200. In user information database 500, personal information on user 100 who is making use of periodic delivery service 1 is stored as user information on user 100 who has completed registration for use of periodic delivery service 1. Specifically, correspondences among identification information on user 100, that is, ID, a name, an address, a phone number, and an e-mail address of user 100, and a leased cooking appliance, a plan, and a start date for use of periodic delivery service 1 are established and stored in user information database 500. For example, in FIG. 5, user 100 with ID “001” has a name “Taro Yamada”, an address”... Kadoma city, Osaka”, a phone number “090-1234-5678”, and an e-mail address “aaa@bbb.com.” Furthermore, in FIG. 5, a leased cooking appliance of periodic delivery service 1 used by user 100 with ID “001” is “microwave oven”; a plan is a “five meal sets” (that is, plan 401); and a start date for use of the service is “2020/8/1.” Note that FIG. 5 is a diagram merely illustrating an example of user information on user 100 stored in user information database 500, hence, a data structure and contents can be suitably changed.

Next, coupon information database 600 stored by coupon information manager 305 will be described using FIG. 6. FIG. 6 is a diagram illustrating coupon information database 600. Coupon information database 600 is a database for information stored in storage device 203 of server 200. In coupon information database 600, correspondences between ID and a name of user 100 as a provision target of coupon information generated to be provided to user 100 and the generated coupon information and an expiration date of the coupon information are established and stored. For example, in FIG. 6, coupon information generated to be provided to user 100 who has ID “001” and a name “Taro Yamada” is “abcd1234”, and an expiration date of the coupon information is “23:59 on Aug. 31, 2020”. FIG. 6 is a diagram illustrating merely an example of information stored in coupon information database 600, and a data structure and contents can be suitably changed. Note that coupon information used once needs to be prevented from being reused. A method for preventing the reuse of the coupon information may be such that, for example, after coupon information manager 305 uses coupon information, the coupon information may be updated to a string of specific letters and numbers (a specific character string) indicating that the coupon information has been already used. Thus, even when user 100 tries to reuse the used coupon information, through the later-described inquiry as to the coupon information, coupon information inputted by user 100 is determined to be erroneous, whereby the use of the erroneous coupon information can be prevented. As another method, for example, coupon information database 600 may have a new data item (not illustrated) indicating whether coupon information corresponding to the data item is used or not. When generating coupon information, coupon information manager 305 registers data indicating yet-to-be-used coupon information (for example, “0”) in the data item. Then, when the coupon information is used, coupon information manager 305 updates the data item to data indicating used coupon information (for example, “1”). During an inquiry as to coupon information, the data item is referred to, whereby it is determined that the coupon information that user 100 tries to use is already used, and thus the use of the coupon information can be prevented.

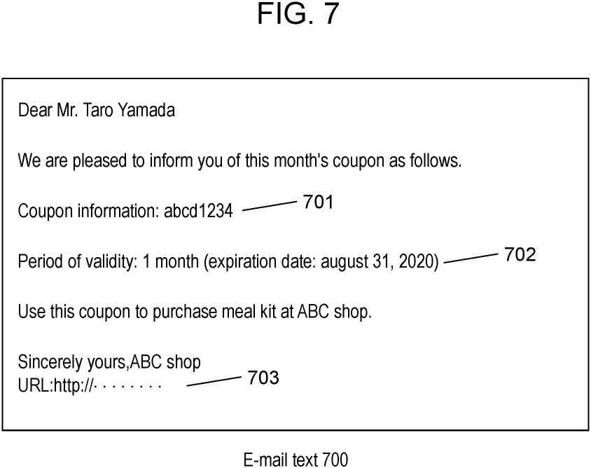

Next, coupon information to be provided to user 100 will be described using FIG. 7. FIG. 7 is a diagram illustrating e-mail text 700 of an e-mail sent to communication terminal 10 of user 100. The e-mail having e-mail text 700 as a body text is generated by coupon information manager 305 and sent to communication terminal 10 of user 100.

As illustrated in FIG. 7, e-mail text 700 includes coupon information 701. E-mail text 700 further includes expiration date 702. Expiration date 702 means an expiration date of coupon information. In the case of periodic delivery service 1 in the present embodiment, the coupon information expires in one month. For example, the expiration date of coupon information is a date one month after the generation of the coupon information (in the present embodiment, a date on which the coupon information is generated is the same as a date on which the e-mail is sent). E-mail text 700 further includes URL 703. URL 703 is the URL of an EC site provided by foodstuff provider 120. That is, the e-mail indicates the URL for accessing the EC site for purchasing a foodstuff. User 100 purchases a foodstuff by using coupon information in the EC site indicated by URL 703 before the expiration date, whereby user 100 can enjoy a meal cooked using a cooking appliance provided by service provider 110.

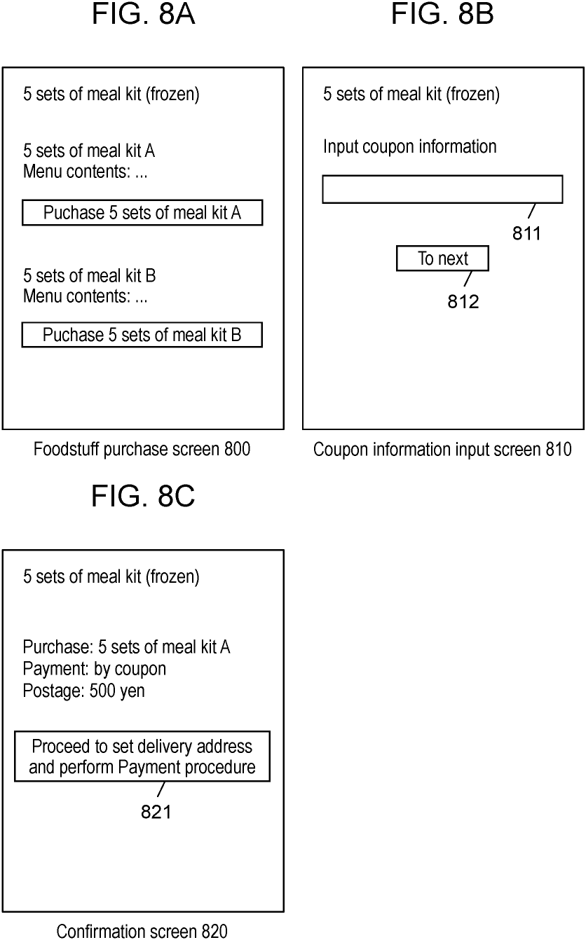

Next, a method for using coupon information will be described using FIG. 8A to FIG. 8C. FIG. 8A to FIG. 8C are diagrams each illustrating a screen provided to communication terminal 10 of user 100 via an EC site of foodstuff provider 120. Specifically, FIG. 8A is a diagram illustrating foodstuff purchase screen 800, FIG. 8B is a diagram illustrating coupon information input screen 810, and FIG. 8C is a diagram illustrating confirmation screen 820.

When user 100 clicks (in the case of a touch panel, touches) URL 703 in e-mail text 700 illustrated in FIG. 7, communication terminal 10 accesses the EC site provided by foodstuff provider 120, so that foodstuff purchase screen 800 in FIG. 8A is displayed on communication terminal 10 of user 100. On foodstuff purchase screen 800, foodstuffs purchasable by user 100 are displayed in accordance with a plan selected by user 100 on the occasion of registration for use of periodic delivery service 1. Although, on foodstuff purchase screen 800, two types of meal kits are displayed as foodstuffs purchasable by user 100, this is merely an example and the number of types of foodstuffs purchasable by user 100 may be three or more or may be only one.

When user 100 selects a desired foodstuff on foodstuff purchase screen 800, coupon information input screen 810 in FIG. 8B is displayed on communication terminal 10 of user 100. User 100 inputs coupon information 701 indicated in e-mail text 700 into input area 811 and clicks button 812. When button 812 is clicked, an inquiry on coupon information is made between server 50 of foodstuff provider 120 and server 200 of service provider 110. That is, the coupon information inputted into input area 811 is verified with coupon information stored in coupon information database 600 and corresponding to user 100. When the coupon information inputted by user 100 is erroneous, an error screen (not illustrated) is displayed on communication terminal 10 of user 100. In contrast, when the coupon information inputted by user 100 is authorized and not-yet-expired coupon information, confirmation screen 820 in FIG. 8C is displayed on communication terminal 10 of user 100. When user 100 clicks button 821 in confirmation screen 820, a delivery address is set and a payment procedure is taken. Although confirmation screen 820 indicates that a shipping charge needs to be paid, the shipping charge may be included in a charge for use of periodic delivery service 1 described in FIG. 4 (see plan 403 and plan 404). As long as a shipping charge is thus included in a charge for use of periodic delivery service 1, it is not necessary to perform the processing of payment in server 50 of foodstuff provider 120, so that convenience for user 100 is increased and server 50 can have a simpler functional configuration.

Note that, when a foodstuff is purchased using coupon information as described above, it is necessary to set the status of this coupon information as already-used. Therefore, for example, upon the completion of a payment procedure or the completion of shipping of a foodstuff, an instruction to set the coupon information as already-used is sent from server 50 of foodstuff provider 120 to server 200 of service provider 110. Server 200 (coupon information manager 305) of service provider 110 having received this instruction updates a record including the coupon information in coupon information database 600 so as to indicate that the coupon information is already used.

As described above, according to periodic delivery service 1 in the present embodiment, user 100 can purchase a foodstuff in the EC site of foodstuff provider 120 by using coupon information provided from service provider 110. User 100 can purchase a foodstuff at a desired timing as long as the coupon information is not yet expired. Therefore, for example, just before a foodstuff purchased using previous coupon information is consumed, user 10 can purchase a new foodstuff. Furthermore, when foodstuff provider 120 adds a new foodstuff, user 100 can purchase the new foodstuff by using coupon information. Thus, service-providing system 300 can increase convenience for user 100.

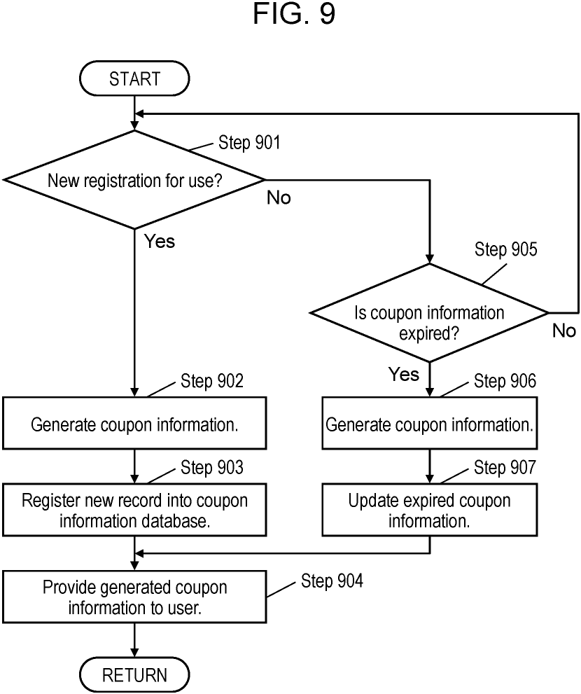

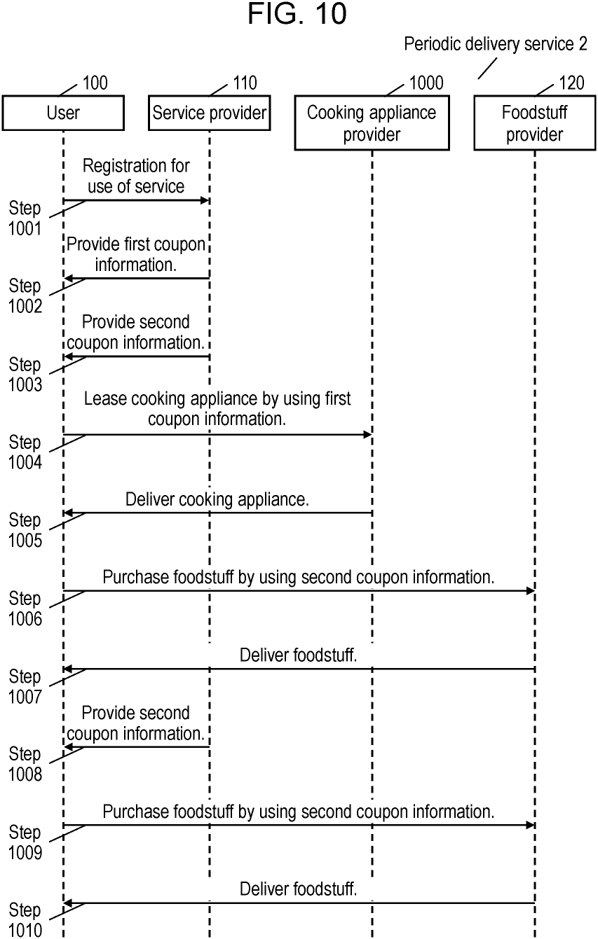

Next, processing in which service provider 110 provides coupon information to user 100 will be described using a flow chart in FIG. 9. FIG. 9 is a flow chart illustrating the processing executed by service-providing system 300. Processor 201 of server 200 reads and executes a control program stored in memory 202, whereby steps illustrated in the flow chart in FIG. 9 are realized.

First, at Step 901, coupon information manager 305 determines whether new registration for use of periodic delivery service 1 in the present embodiment is made or not. If personal information of new user 100 is registered in user information database 500, coupon information manager 305 determines that new registration for use has been made (Yes at Step 901), the processing proceeds to Step 902. In contrast, if personal information of a new user is not registered in user information database 500, coupon information manager 305 determines that new usage registration has not been made (No at Step 901), the processing proceeds to Step 905.

Next, Step 902 will be described. At Step 902, coupon information manager 305 generates new coupon information. In the present embodiment, coupon information is exemplarily a string of random letters and numbers, but may be another aspect, for example, a character string composed of only random letters or a numerical sequence composed of only random numbers.

Next, at Step 903, coupon information manager 305 registers a new record in coupon information database 600 by using coupon information generated at Step 902. That is, coupon information manager 305 acquires the ID and name of new user 100 registered in user information database 500, and registers a record including the acquired ID and name and the generated coupon information and an expiration date in coupon information database 600.

Next, at Step 904, coupon information manager 305 provides the coupon information generated at Step 902 to user 100. A method for providing the coupon information to user 100 is such that, for example, as described in FIG. 7, coupon information manager 305 sends, to communication terminal 10 of user 100, an e-mail including coupon information indicated in an e-mail text. When the coupon information generated at Step 902 is provided to user 100, the processing returns to Step 901.

Next, Step 905 will be described. At Step 905, coupon information manager 305 checks coupon information database 600 and determines whether or not expired coupon information is present. If expired coupon information is present (Yes at Step 905), the processing proceeds to Step 906. In contrast, if expired coupon information is absent (No at Step 905), the processing returns to Step 901.

Next, Step 906 will be described. At Step 906, coupon information manager 305 generates new coupon information. This processing is the same as that at Step 902. That is, if expired coupon information is present (Yes at Step 905), coupon information manager 305 generates new coupon information (Step 906).

Next, at Step 907, coupon information manager 305 updates the expired coupon information by using the coupon information generated at Step 906. At this time, the expiration date is also updated. Then, at Step 904, the coupon information generated at Step 906 is provided to user 100.

Note that, at Step 904, as an example of the method for providing the newly generated coupon information to user 100, there was described a method in which an e-mail including coupon information indicated in an e-mail text is sent to communication terminal 10 of user 100. The method for providing new coupon information to user 100 is not limited to the above-described method, but may be any of the following other provision methods.

### Other Provision Method 1

Other Provision Method 1 is a method in which new coupon information itself is not included in an e-mail sent to communication terminal 10 of user 100, but a URL for confirmation that allows confirmation of the new coupon information is included therein. When confirming this mail, user 100 clicks the URL for confirmation to confirm the new coupon information. That is, when generating coupon information on user 100, coupon information manager 305 may send an e-mail including a URL for acquiring the generated coupon information to an e-mail address of user 100.

### Other Provision Method 2

Other Provision Method 2 is a method in which the issuance of new coupon information is indicated in an e-mail sent to communication terminal 10 of user 100, but the coupon information itself is not indicated in the e-mail. After the confirmation of the e-mail, user 100 logs into a Web site of service provider 110 and checks new coupon information on My Page or the like. That is, when generating coupon information on user 100, coupon information manager 305 may send, to an e-mail address of user 100, an e-mail to inform user 100 of the issuance of the coupon information.

### Other Provision Method 3

Other Provision Method 3 is a method in which a QR Code (registered trademark) indicating new coupon information or a QR Code (registered trademark) indicating a URL allowing confirmation of the new coupon information is included in an e-mail sent to communication terminal 10 of user 100. User 100 reads the QR Code by using a smart phone or the like to acquire the new coupon information.

### Other Provision Method 4

Other Provision Method 4 is a method in which an application prepared for periodic delivery service 1 of the present embodiment by service provider 110 is installed in communication terminal 10 of user 100. Server 200 provides, to the application, Push-notification of the issuance of new coupon information, and, when confirming this Push-notification, user 100 confirms the new coupon information on the application.

### Other Provision Method 5

Other Provision Method 5 is a method in which a mail including new coupon information is sent to an address of user 100.

### Other Provision Method 6

Other Provision Method 6 is a method in which a piece of paper including any one of new coupon information itself, a QR Code indicating the new coupon information, and a QR Code indicating a URL allowing confirmation of the new coupon information is packaged with a cooking appliance or a foodstuff to be delivered to user 100. This piece of paper may also serve as an advertisement. Alternatively, any one of the new coupon information itself, the QR Code indicating the new coupon information, and the QR Code indicating the URL allowing confirmation of the new coupon information may not be indicated in a piece of paper, but may be indicated in a label to be affixed to the cooking appliance or the foodstuff. Note that, in the case where coupon information is packaged with a foodstuff, there is adopted a flow slightly different from the flow of periodic delivery service 1 illustrated in FIG. 1. That is, in the case where coupon information is packaged with a foodstuff, the packaging cannot be performed in the first provision of coupon information at Step 103, but the packaging is performed for the first time in the second provision of the coupon information. In this case, the processing at Step 106 is omitted. In this case, at Step 105, server 50 of foodstuff provider 120 acquires coupon information from server 200 of service provider 110, and packages the acquired coupon information with the foodstuff and provides the coupon information. As described above, a method for the second and subsequent provision of the coupon information is sometimes different from the method for the first provision of coupon information. That is, a method for providing coupon information generated at Step 902 may be different from a method for providing coupon information generated at Step 906.

As described above, service-providing system 300 in Embodiment 1 is capable of providing a mechanism configured to provide periodic delivery service 1 including a combination of the provision of a cooking appliance and the provision of a foodstuff corresponding to the cooking appliance. Specifically, service provider 110 provides user 100 with a cooking appliance, and provides user 100 with coupon information allowing purchase of a foodstuff corresponding to the cooking appliance. Thus, the system is advantageous to service provider 110 in that, in place of service provider 110, foodstuff provider 120 sales foodstuffs and delivers the foodstuffs to user 100. Hence, even when service provider 110 does not have know-how about foodstuff manufacture, sale, delivery, and the like, service provider 110 can promptly start a new service including a combination of the provision of a cooking appliance and the provision of a foodstuff. Furthermore, the system is advantageous to foodstuff provider 120 in that new customers are introduced by service provider 110 and accordingly sales and awareness of foodstuff provider 120 can be increased. Furthermore, the system is advantageous to user 100 in that a foodstuff suitable for a provided cooking appliance is provided to user 100 at a desired timing. Therefore, compared with the case of providing a foodstuff at a predetermined timing, service-providing system 300 can further increase convenience for user 100.

### Embodiment 2

In Embodiment 1, the example in which service provider 110 provides a cooking appliance to user 100 was described. In Embodiment 2, an example in which a company different from service provider 110 provides user 100 with a cooking appliance will be described as a modified example of Embodiment 1.

A coupon information manager of a service-providing system in Embodiment 2 is different from coupon information manager 305 of service-providing system 300 in Embodiment 1 in that the coupon information manager in Embodiment 2 generates and stores first coupon information and second coupon information. The first coupon information allows the leasing of a cooking appliance. The second coupon information is different in name from the coupon information in Embodiment 1, but is actually the same as the coupon information in Embodiment 1, and allows purchase of a foodstuff. The second coupon information is periodically provided to user 100.

Accordingly, in a database stored in the coupon information manager in Embodiment 2, first coupon information and second coupon information are stored in place of the coupon information as a data item of coupon information database 600 in Embodiment 1. Except the above, the system configuration of the service-providing system in Embodiment 2 is the same as that of service-providing system 300 in Embodiment 1.

The flow of periodic delivery service 2 in the present embodiment will be described using FIG. 10. FIG. 10 is a diagram illustrating the flow of periodic delivery service 2 in Embodiment 2. As illustrated in FIG. 10, using communication terminal 10 owned by user 100, user 100 accesses a Web page prepared by service provider 110, selects a desired plan, and performs registration for use of periodic delivery service 2 (Step 1001). When the registration for use is completed, service provider 110 provides user 100 with the first coupon information allowing the leasing of a cooking appliance and the second coupon information allowing purchase of a foodstuff (Step 1002 and Step 1003). Note that, like the coupon information in Embodiment 1, the first coupon information and the second coupon information are each composed of, for example, a string of random letters and numbers. A method for providing the first coupon information and the second coupon information is the same as the method for providing the coupon information in Embodiment 1, in other words, may be a method using an e-mail or an application or may be a method using a medium such as paper or a label.

Using communication terminal 10, user 100 accesses an EC site prepared by cooking appliance provider 1000 and orders the leasing of a cooking appliance by using the first coupon information (Step 1004). Cooking appliance provider 1000 delivers the cooking appliance ordered by user 100 to user 100 (Step 1005).

Using communication terminal 10, user 100 accesses an EC site prepared by foodstuff provider 120 and purchases a foodstuff by using the second coupon information (Step 1006). Foodstuff provider 120 delivers the foodstuff purchased by user 100 to user 100 (Step 1007). User 100 can cook the foodstuff purchased from foodstuff provider 120 by using the cooking appliance leased from cooking appliance provider 110 and enjoy a meal.

Distribution of the second coupon information to user 100 is periodically performed. For example, after the elapse of one month following the first provision of the second coupon information (Step 1003), the next provision of the second coupon information to user 100 is performed by service provider 110 (Step 1008). User 100 can purchase the foodstuff again by using this second coupon information (Step 1009 and Step 1010).

As described above, the service-providing system in Embodiment 2 is capable of providing a mechanism configured to provide periodic delivery service 2 including a combination of the provision of a cooking appliance and the provision of a foodstuff corresponding to the cooking appliance. Specifically, service provider 110 provides user 100 with the first coupon information for leasing a cooking appliance, and provides user 100 with the second coupon information allowing purchase of a foodstuff corresponding to the cooking appliance. This mechanism is advantageous to service provider 110 in that, in place of service provider 110, cooking appliance provider 1000 prepares a cooking appliance and delivers the cooking appliance to user 100, and foodstuff provider 120 sales a foodstuff and delivers the foodstuff to user 100. Hence, even when service provider 110 does not have know-how about the manufacture, sale, and delivery of cooking appliances and foodstuffs, service provider 110 can promptly start a new service including a combination of the provision of a cooking appliance and the provision of a foodstuff. Furthermore, this mechanism is advantageous to cooking appliance provider 1000 and foodstuff provider 120 in that new customers are introduced by service provider 110, whereby sales and awareness of cooking appliance provider 1000 and foodstuff provider 120 can be increased. Furthermore, this mechanism is advantageous to user 100 in that a foodstuff suitable for a provided cooking appliance is provided to user 100 at a desired timing. Therefore, compared with the case of providing a foodstuff at a predetermined timing, the service-providing system according to Embodiment 2 can achieve greater convenience for user 100.

### Embodiment 3

In the above-described embodiments, periodic delivery services 1 and 2 each including a combination of the provision of a cooking appliance and the provision of a foodstuff are described as examples of the service in the present disclosure. However, what the service provides in the present disclosure is not limited to a combination of a cooking appliance and a foodstuff. As described above, a cooking appliance is an example of the home appliance in the present disclosure, and a foodstuff is an example of the consumable item in the present disclosure. In other words, examples of what the service provides in the present disclosure include the following combinations of home appliances and consumable items corresponding to the respective home appliances.

### Other Combination Example 1

Other Combination Example 1 is a combination of a dishwasher and coupon information allowing purchase of a detergent specifically designed for the dishwasher.

### Other Combination Example 2

Other Combination Example 2 is a combination of a washing machine and coupon information allowing purchase of a detergent specifically designed for the washing machine.

### Other Combination Example 3

Other Combination Example 3 is a combination of a vacuum cleaner and coupon information allowing purchase of a paper dust bag.

### Other Combination Example 4

Other Combination Example 4 is a combination of an air cleaner and coupon information allowing purchase of a filter.

### Other Combination Example 5

Other Combination Example 5 is a combination of a refrigerator and coupon information allowing purchase of foodstuffs (such as eggs and milk).

### Other Combination Example 6

Other Combination Example 6 is a combination of a television and coupon information allowing purchase of distributed video contents.

As described above, the service-providing system in the present disclosure is applicable to a service including combinations of the provision of various home appliances and the provision of consumable items corresponding to the respective home appliances.

Note that service-providing system 300 in Embodiment 1 includes two servers, namely, server 50 and server 200, but service-providing system 300 may include only one server. The same goes to the service-providing systems in Embodiment 2 and Embodiment 3.

### INDUSTRIAL APPLICABILITY

The service-providing system in the present disclosure is applicable to the provision of a service related to the provision of a home appliance.

### REFERENCE MARKS IN THE DRAWINGS

1... periodic delivery service
2... periodic delivery service
10... communication terminal
30... base station
50... server
100... user
110... service provider
120... foodstuff provider
200... server
201... processor
202... memory
203... storage device
204... communication device
300... service-providing system
301... screen provider
302... payment processor
303... cooking appliance manager
304... user information manager
305... coupon information manager
400... registration screen
401... plan
402... plan
403...plan
404... plan
500... user information database
600... coupon information database
700... e-mail text
701... coupon information
702... expiration date
703... URL
800... foodstuff purchase screen
810... coupon information input screen
811...input area
812... button
820... confirmation screen
821... button
1000... cooking appliance provider

What is claimed is:

1. A service-providing system, comprising:
a screen provider configured to provide a communication terminal of a user with a registration screen for registration for use of a service,
the service including a combination of provision of a home appliance and periodic provision of coupon information,
the coupon information allowing purchase of a consumable item corresponding to the home appliance;
a user information manager configured to store user information on the user completing the registration for use of the service; and
a coupon information manager configured to periodically generate the coupon information,
the coupon information being to be provided to the user on whom the user information is stored in the user information manager.

2. The service-providing system according to claim 1,
wherein the user information includes at least an e-mail address, and
wherein, when the coupon information manager generates the coupon information, the coupon information manager sends, to the e-mail address, an e-mail including the coupon information generated.

3. The service-providing system according to claim 1,
wherein the user information includes at least an e-mail address, and
wherein, when the coupon information manager generates the coupon information, the coupon information manager sends, to the e-mail address, an e-mail including a uniform resource locator (URL) allowing acquisition of the coupon information generated.

4. The service-providing system according to claim 1,
wherein the user information includes at least an e-mail address, and
wherein, when the coupon information manager generates the coupon information, the coupon information manager sends, to the e-mail address, an e-mail to inform the user of issuance of the coupon information.

5. The service-providing system according to claim 2,
wherein the home appliance is a cooking appliance,
wherein the consumable item is a foodstuff, and
wherein the e-mail includes a uniform resource locator (URL) allowing access to an electronic commerce (EC) site for purchasing the foodstuff.

6. The service-providing system according to claim 5,
wherein the cooking appliance is a rice cooker or a microwave oven, and
wherein the coupon information manager establishes a correspondence between the coupon information generated and an expiration date of the coupon information and stores the coupon information and the expiration date, and, when the coupon information is expired, the coupon information manager newly generates the coupon information.
